(19) United States
(12) Patent Application Publication
(10) Pub. No.: US 2003/0077178 A1
(43) Pub. Date: Apr. 24, 2003

(54) Wind turbine blade

(76) Inventor: Paul Stearns, Toronto (CA)

Correspondence Address: ELIAS C. BORGES, BORGES BANASINSKI ROLLE LLP, 10 KINGSBRIDGE GARDEN CIRCLE, SUITE 704, MISSISSAUGA, ON, L5R 3K6, CA

(21) Appl. No.: 10/274,530

(22) Filed: Oct. 16, 2002

(30) Foreign Application Priority Data
Oct. 22, 2001 (CA) 2,359,535

(51) Int. Cl. F03B 3/12

(52) U.S. Cl. 416/223 R

(57) ABSTRACT

A wind turbine blade having an improved balance of strength, weight and aerodynamic characteristics suitable for use with a governing mechanism includes an elongated member having a cross-sectional profile having a top surface, a leading edge, a trailing edge and a bottom surface between the leading and trailing edges. The top surface of the profile is configured to be substantially in the form of a standard airfoil. The leading edge is configured to be substantially in the form of a standard air foil while the bottom surface is configured to have a concave surface extending between the leading edge and the trailing edge. The elongated member is preferably a hollow chord made from a rectangular sheet of aluminum having an elongated central portion and opposite side edges. The blade is formed by folding the sheet along its central portion and rigidly attaching the side edges to each other. The central portion may be stamped prior to the attachment of the side edges to impress the form of the leading edges and the top and bottom surfaces.

### FIELD OF THE INVENTION

The present invention relates to wind turbines and more particularly to blades for use in speed governed wind turbines.

### BACKGROUND OF THE INVENTION

Wind turbines are the preferred method of extracting energy from wind. Wind turbines come in two general forms depending on how their blades are mounted. By far the majority of wind turbines have horizontally mounted blades, where the blades are mounted to a hub which in turn is rotatably mounted to a support structure which holds the blades such that their axis of rotation is substantially horizontal. In horizontally mounted wind turbines, the blades rotate in a plane which is perpendicular to the direction of the wind. Each blade is positioned at an angle and is design to rotate when acted on by the wind. As the wind speed increases, the blades rotate faster, thereby extracting more energy from the wind. The hub is generally coupled to an electric generator such that as the blades rotate, the generator converts the energy of the rotating blades into electric current. The faster the blades rotate, the more energy is generated by the electric generator.

Several improvements and adaptations have been made to horizontal wind turbines in order to increase the efficiency and practicality. A majority of the developments have centered on the design and operation of the blades. The first wind turbine blade designs consisted of little more than flat surfaces placed at acute angles. As the science of wind turbines advanced, airfoil designs were applied to wind turbine blades. It was discovered that applying airfoil designs to wind turbine blades significantly increased the efficiency of the wind turbine. The airfoil blades generate lift in the presence of a strong enough wind, the lift in turn generating the force required to turn the wind turbine blade assembly. The more efficient the airfoil, the more efficient the turbine. The efficiency of the turbine blade is determined in part by the nature of the airfoil applied to the blade and the angle of attack of the blade. The optimum angle of attack for a wind turbine blade depends on the nature of the air foil design of the blade and the speed of the incident wind. With the exception of large wind turbine devices (in excess of 5 kwatts or more) few wind turbines are adapted to change the angle of attack of the blades to optimize efficiency.

The efficiency of a wind turbine is best characterized by the ratio of the blade tip speed to the speed of the incident wind acting on the turbine. For a turbine having three blades, it is generally accepted that a blade tip ratio approaching 6 to 1 (i.e. six times the incident wind speed) represents a wind turbine rotor with high efficiency. In such a turbine, if the wind speed is 30 km/hr, the blades will be traveling at approximately 180 km/hr. As can be appreciated, the centrifugal forces acting on blade traveling at such a high speed are considerable. To overcome this problem, research and development in the field of optimum wind turbine blade design has focused on creating blades with increased strength in the axial direction. Such blades, generally made of fiberglass, carbon fibre composites or high strength plastics, could spin at much higher speeds and therefore extract more energy from the wind. While composite blades do have increased strength in the axial direction, they have relatively low strength in the transverse directions, making these blades prone to bending and flapping in strong winds. The chaotic nature of wind tends to cause composite blades to flap and vibrate, which at high rotational speeds, can have disastrous consequences. Furthermore, in order to extract the maximum amount of energy for any given blade design, such a blade would have to be rotatably adjustable in order to optimally vary the angle of attack to suit the wind speed. Unfortunately, the inherent lack of stiffness in prior art wind blades precludes this. Therefore, despite all the achievements in new wind turbine blade designs, a majority of three bladed wind turbine generator devices have blade tip rations lower than optimal.

### SUMMARY OF THE INVENTION

In accordance with one aspect of the present invention, there is provided an improved wind turbine blade consisting of an elongated member having a cross-sectional profile. The cross-sectional profile has a top surface, a leading edge, a trailing edge and a bottom surface between the leading and trailing edges. The top surface of the profile is configured to conform substantially to a standard lifting wing airfoil. The leading edge of the elongated member is configured to substantially conform to a standard air foil. The bottom surface of the elongated member is configured to have a concave surface extending between the leading edge and the trailing edge.

In accordance with another aspect of the present invention, there is provided an improved turbine blade for use in a wind turbine consisting of an elongated hollow chord having a cross-sectional profile substantially in the form of a standard lifting wing airfoil having a top surface, a bottom surface, a leading edge and a trailing edge. The chord is made from an elongated sheet of metal having opposite first and second edges, an elongated central portion, an elongated first portion extending between the central portion and the first edge and an elongated second portion extending between the central portion and the second edge. The first portion of the sheet is configured to form the top surface of the profile, the second portion of the sheet is configured to form the bottom surface of the airfoil, and the central portion of the sheet is configured to form the leading edge. The opposite side edges of the sheet are rigidly attached together to form the trailing edge.

In accordance with another aspect of the present invention, there is provided an improved wind turbine blade assembly consisting of a hub rotatably mountable to a housing with at least two turbine blades mounted to the hub, each blade having a leading edge and a longitudinal axis, the hub positioning the blades to rotate in a plane of rotation. Each blade is pivotally mounted to the hub such that the blade may pivot about it long axis between a first position wherein the blade is positioned at a first angle of attack relative to the plane of rotation and a second position wherein the blade is positioned at a second angle of attack of about 0° relative to the plane of rotation. The assembly also includes a pivoting mechanism operatively coupled to each blade for pivoting the blade into the second position when the blade assembly is rotated beyond a preselected limit.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a front view of a wind turbine blade assembly made in accordance with the present invention mounted on a support tower.

FIG. 2. is a perspective view of a wind turbine blade made in accordance with the present invention.

FIG. 3. is a cross-sectional view of a wind turbine blade made in accordance with the present invention.

FIG. 4a. is a front view of a metal sheet to be formed into a wind turbine blade in accordance with the method of the present invention.

FIG. 4b. is a cross sectional view of the sheet shown in FIG. 4a.

FIG. 4c. is a cross sectional view of the sheet shown in FIG. 4b after being deformed in accordance with the method of the present invention.

FIG. 4d. is a cross sectional view of the sheet shown in FIG. 4c after being deformed in accordance with the method of the present invention.

FIG. 4e. is a cross sectional view of a turbine blade made in accordance with the present invention from the sheet shown in FIG. 4d.

FIG. 5a. is a cross sectional view of two sheets of metal about to be formed into the wind turbine blade of the present invention.

FIG. 5b. is a cross sectional view of the sheets shown in FIG. 5a after being deformed in accordance with the method of the present invention.

FIG. 5c. is a cross sectional view of an airfoil made in accordance with the present invention from the sheets shown in FIG. 5b.

FIG. 6a. a is a cross sectional view of a turbine blade of the present invention in its incipient stall position.

FIG. 6b. is a cross sectional view of a wind turbine blade of the present invention in its optimum lift position.

FIG. 6c. is a cross sectional view of a wind turbine blade of the present invention in its zero angle of attack position.

FIG. 7. is a perspective view of a prior art wind turbine blade.

FIG. 8. is a cross-sectional view of a portion of the prior art wind turbine blade shown in FIG. 7.

FIG. 9. is a cross-sectional view of a prior art gas turbine blade.

FIG. 10. is a graphical representation of the performance of a wind turbine made in accordance with the present invention showing the power output of the wind turbine as a function of wind speed.

FIG. 11. is a graphical representation of the performance of a prior art wind turbine showing the power output of the wind turbine as a function of wind speed.

In the drawings like characters of reference indicate corresponding parts in the different figures.

### DETAILED DESCRIPTION OF THE INVENTION

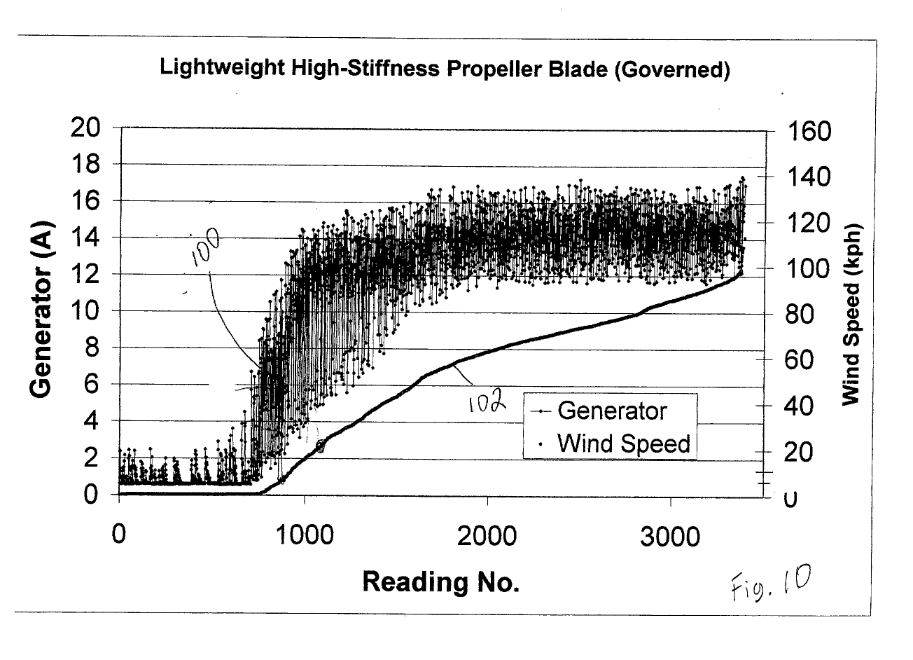

Referring firstly to FIGS. 7, 8 and 9, a brief discussion of prior art wind turbine blades shall be discussed. Prior art wind turbine blades, shown generally as item 200, generally consist of an elongated member having a terminal end 214, a leading edge 210, a trailing edge 212 and a hub end 216. Wind turbine blade 200 has a cross-sectional profile substantially in the form of a traditional air foil, with a curved top surface 218 and a substantially flat or slightly convex bottom surface 220. When incorporated into the blade assembly of a wind turbine, the blade is oriented such that bottom surface 220 faces the wind. The airfoil cross-sectional profile of turbine blade 200 gives the blades aerodynamic lift when acted upon by the wind, much like the wing of an airplane. The lift created by the wind turbine blade forces the blades to rotate. Generally, prior art turbine blades 200 will taper from the hub portion 216 towards terminal portion 214. The tapering assists in lowering the drag forces which act on the blade tip at high speeds, which in turn increases the efficient operation of the blade at high wind speeds. Since the blade will be exposed to high centrifugal forces, particularly at high rotational speeds, the blade in a typically small wind turbine is generally a solid structure made from a strong material such as a carbon or glass fibre composite.

In contrast to the smooth and substantially flat air foil design of wind turbine blade 200, gas turbine blade 230 has a highly concave lower surface 232. In operation, the highly curved lower surface permits the gas turbine blade to extract more energy from the heated high pressure gas in a turbine engine (not shown). The highly concave lower surface of gas turbine blade 230 makes the gas turbine design highly inefficient as a wind turbine blade, due to the greatly increased drag intrinsic in such a design. As a result, virtually all prior art wind turbines use a variation of the airfoil design shown in FIG. 7, namely a linear or tapered chord.

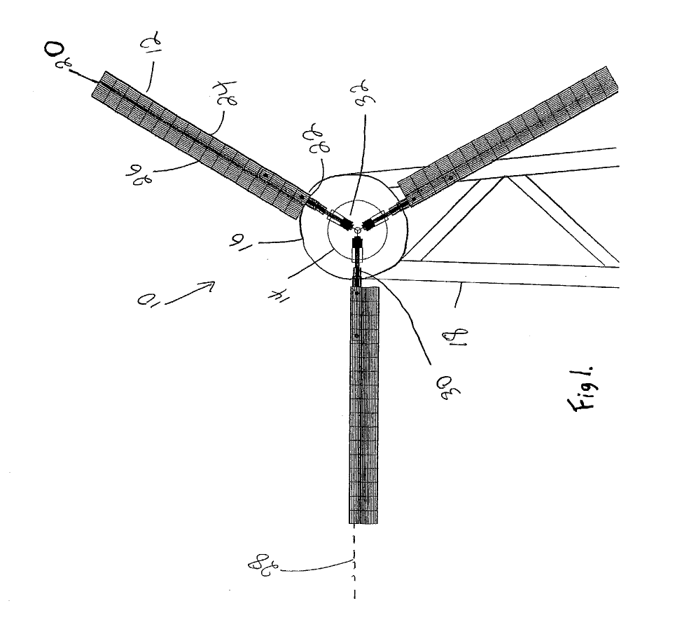

Referring now to FIG. 1, the present invention is a wind turbine blade assembly, shown generally as item 10 which consists of a plurality of elongated turbine blades 12 pivotally mounted to a hub 14. Hub 14 will generally be mounted to a dynamo (generator) 16 which in turn will be mounted to support tower 18. Blade 12 has terminal end 20, hub end 22, leading edge 24, trailing edge 26 and long axis 28. Hub end 22 of blades 12 are provided with shafts 30, which couple the hub end to hub 14. Hub 14 includes a centrifugal governor 32 which is operatively coupled to shafts 30 of blades 12 and is adapted to pivot the blades about their longitudinal axis 28.

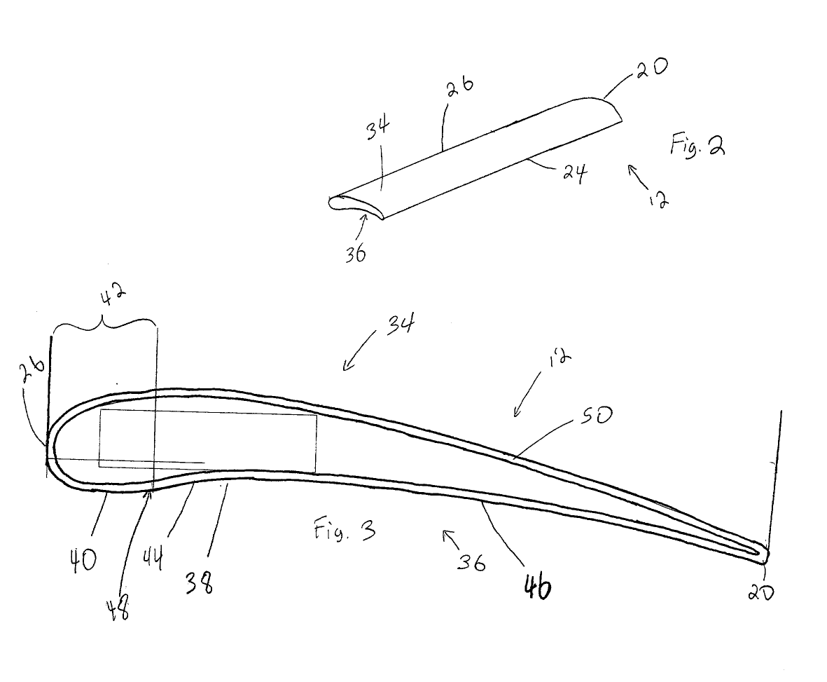

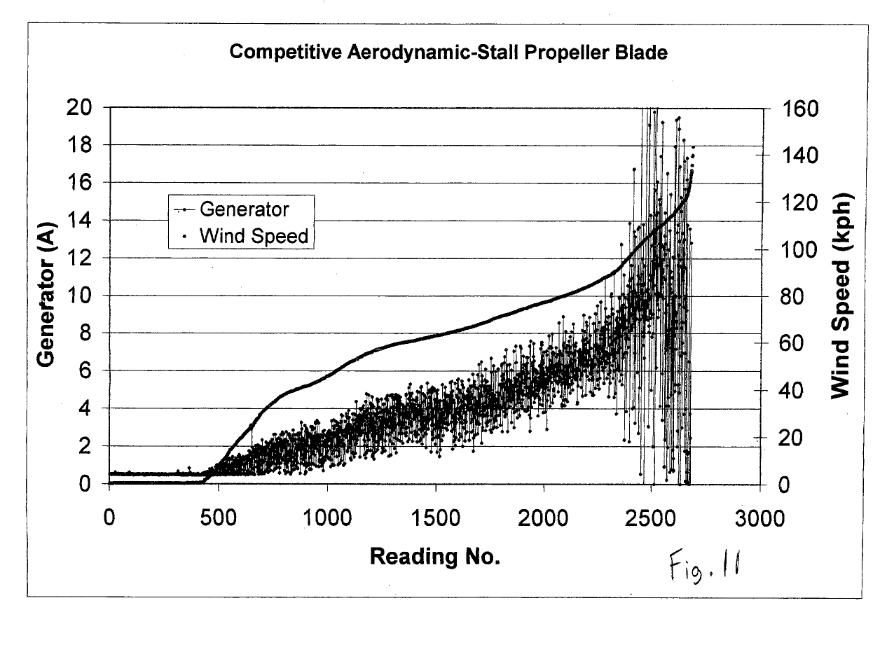

Referring now to FIGS. 2 and 3, blade 12 consists of an elongated hollow chord having an aerodynamic cross-sectional profile with top surface 34 and bottom surface 36. Top surface 34 is formed substantially in the same manner as a traditional lifting airfoil as found on the wing of a subsonic plane or in a more traditional wind turbine blade (see FIG. 8). Leading edge 26 is also formed in substantially the same way as a traditional lifting airfoil. Immediately behind leading edge 26 is a lower edge surface 40 which is configured to be substantially flat, as in a traditional lifting airfoil (see FIG. 9). Lower edge surface 40 extends for a length 42, which is between 10% to 20% of the width of blade 12 between leading edge 26 and trailing edge 20. Immediately behind surface 40 is concave section 38, which has front face 44 and trailing face 46. Trailing face 46 gently tapers towards trailing edge 20. Front face 44, being steeper than trailing face 46, departs abruptly from lower edge surface 40 at transition zone 48.

Concave section 38 of surface 36 is structurally and functionally similar to a gas turbine blade (see FIG. 10) and, as will be discussed, gives blade 12 greatly improved performance, particularly in low wind speeds and high angles of attack. In addition to providing the airfoil with improved performance, concave section 38 adds considerable rigidity to blade 12 making the blade much more resistant to twisting and bending. As shall be discussed, this increased rigidity permits the blade to be used in a manner previously seldom considered in a wind turbine blade.

To keep its weight as low as possible, blade 12 is constructed as a hollow chord having a wall 50. Preferably, blade 12 will be made from aluminum. While blade 12 may be made as an aluminum extrusion, it has been discovered that a blade having superior strength to weight ratio will result if sheet aluminum is used rather than extruded aluminum. Sheet aluminum has a homogenous crystal structure which gives the sheet superior strength characteristics and formability. Consequently, when sheet aluminum is used to construct wall 50 of blade 12, a very rigid yet light structure results. Concave section 38 of lower surface 36 adds considerable structural rigidity to blade 12, particularly if the blade is made from sheet aluminum. The combination of using sheet aluminum to construct blade 12 and the structure of concave section 38 of lower surface 36 results in wind turbine blade having superior strength, rigidity and lightness, all of which permit the blade to function much better than other wind turbine blades, particularly when employed in a rotatable governor actuated form.

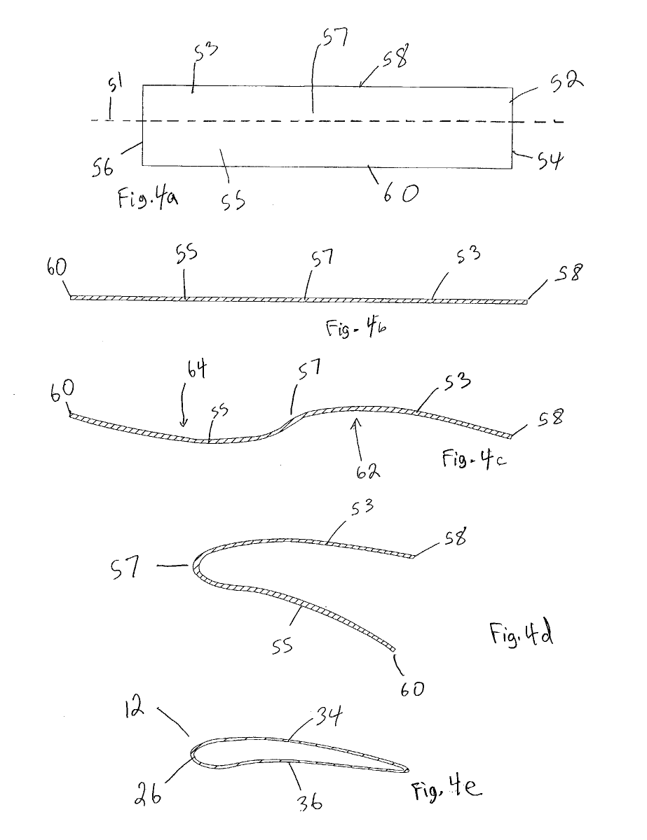

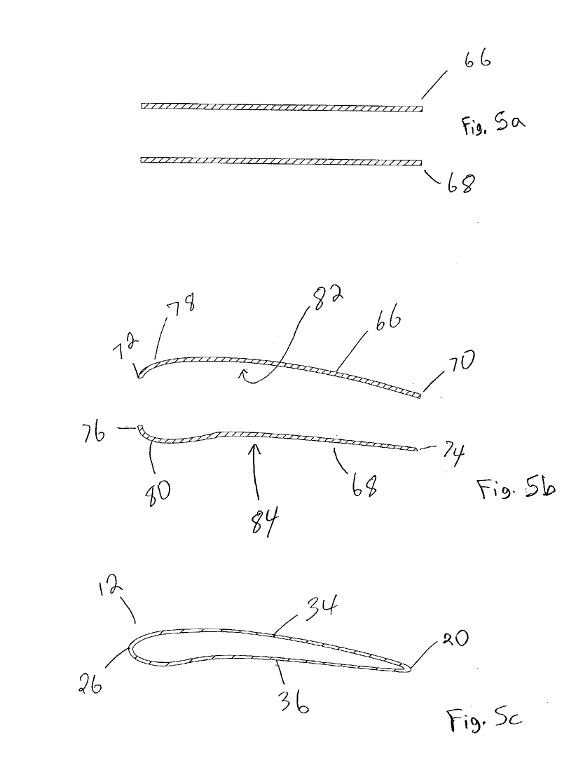

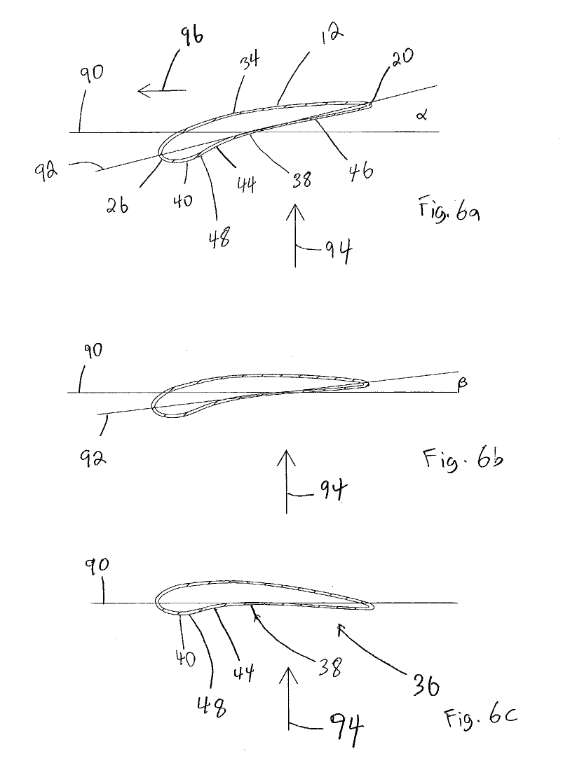

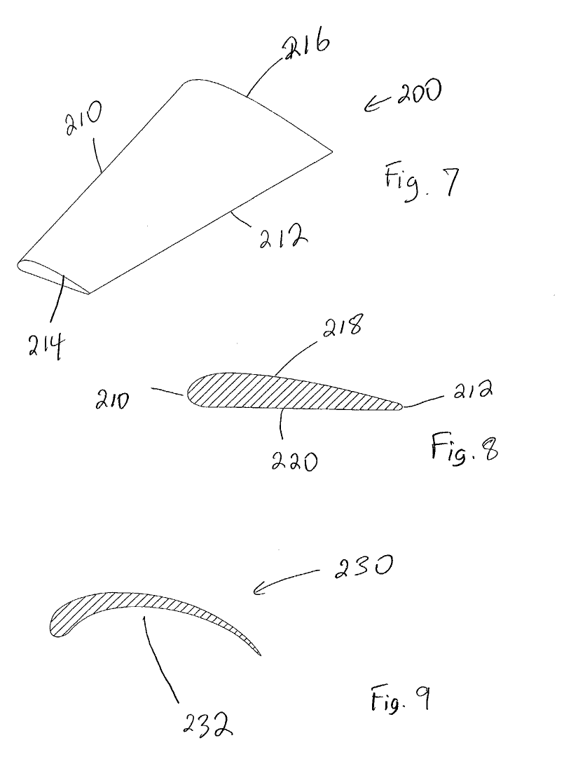

Referring now to FIGS. 4a through 4e, the preferred method of constructing the wind turbine blade shall now be discussed. Blade 12 is preferably made from a single elongated sheet of aluminum 52 having longitudinal axis 51, ends 54 and 56, opposite side edges 58 and 60 and sections 53 and 55 adjacent side edges 58 and 60, respectively and elongated central portion 57 positioned between sections 53 and 55. Sheet 52 is preferably a standard sheet of aluminum having a thickness of about 0.03 inches. Other light sheeting material can be substituted for sheet 52; however, aluminum sheeting is preferred because it is inexpensive, light, weather resistant, and has a high practical specific stiffness.

To form the modified airfoil profile shown in FIG. 4e, sheet 52 is cold stamped and folded using standard metal forming equipment. Sections 53 and 55 are stamped to leave impressions 62 and 64, respectively. Impression 62 defines the curvature of upper surface 34 of finished blade 12 (see FIG. 4d), while impression 64 defines the curvature of lower surface 36 of the blade. In order to maximize the strength of the finished blade, the stamping is preferably performed at room temperature. If the stamping is performed at an elevated temperature, then the crystal structure of the aluminum sheet may change resulting in a product which is less rigid.

Sheet 52 is folded along central portion 57 to bring portions 53 and 55 towards each other until side edges 58 and 60 contact each other. Preferably, central portion 57 is folded such that it forms leading edge 26. Specialized folding tools (not shown) are generally available which can be readily adapted to fold sheet 52 as described above. To complete the construction of the wind turbine blade, edges 58 and 60 are rigidly attached to each other by any suitable method such as welding, bonding, riveting or folding. It has been discovered that a particularly strong and rigid blade is formed when edges 58 and 60 are joined together by continuous welding. The welded edges form trailing edge 20 of the finished turbine blade.

In some circumstances, it may be more economical to construct wind turbine blades out of two or more sheets of metal. FIGS. 5a to 5c illustrate how a wind turbine blade made in accordance with the present invention may be constructed from two sheets of aluminum 66 and 68. Sheet 66 is to form upper surface 34 of wind turbine blade 12 while sheet 68 shall form lower surface 36 of the wind turbine blade. Sheet 66 has opposite ends 72 and 70 and a forward section 78 adjacent end 72. Sheet 68 has opposite ends 76 and 74 and forward section 80 adjacent end 76. Impressions 82 and 84 are stamped into sheets 66 and 68, respectively, by standard stamping tools (not shown). Impressions 82 and 84 are configured to create the curves of upper surface 34 and lower surface 36, respectively, of wind turbine blade 12. To complete the construction of the wind turbine blade, edges 72 and 76 and edges 70 and 74 are rigidly attached to each other by means known generally in the art. The final product is a rigid yet very light wind turbine blade.

Referring now to FIGS. 6a to 6c, the operation of the wind turbine blade shall now be discussed. Blade 12 is positioned on a wind turbine blade assembly (see FIG. 1) such that the blade shall rotate in a plane of rotation indicated by line 90 and in the direction indicated by arrow 96. Blade 12 has a transverse axis indicated by line 92. At rest, blade 12 is preferably placed at an angle α from the plane of rotation 90. Angle α is preferably selected to be just below the incipient stall angle for the blade. The incipient stall angle for a wind turbine blade can be defined as the angle of attach at which a stall condition begins to occur. The incipient stall angle will vary slightly depending on the shape of the airfoil, but for wind turbine blades having the airfoil shown in FIG. 6a, the incipient stall angle will be approximately 16° to 20°; therefore, the value of α for the present example is selected to be approximately 18°. With blade 12 set at an angle of attack of just below its incipient stall angle, it has been discovered that the blade will generate lift and otherwise rotate aggressively even at very low wind speeds. When blade 12 is at an angle of attack of about 18°, the incident wind, the direction of which is indicated by arrow 94, impinges upon concave surface 38. The concave configuration of surface 38 causes blade 12 to behave in the manner of a gas turbine blade, resulting in the creation of lift and momentum transfer even at wind speeds as low as 6 km/hr. The lift created in blade 12 translates into a resultant force vector indicated by arrow 96 causing the blade to rotate in plane 90. Setting α to greater than 18° will not increase lift because the blade will be in a stall condition, and an airfoil in a stall condition generates little lift.

As is well know in the art, reducing the angle of attack of a wing airfoil from incipient stall causes lift to initially increase and reach a peak at approximately 10°. When the angle of attack is reduced further, the lift generated by the airfoil begins to drop. It is believed that when blade 12 is at its optimal angle of attack as indicated by angle β, the blade acts less like a gas turbine blade and more like a traditional wing airfoil with a substaintial broadened left regime. Therefore, to maximize the performance of the blade, as the speed of the wind acting on the blade increases, the angle of attack is decreased from a sub-stall angle of 18° towards a more ideal angle of 10° to 12°. Of course, as soon as blade 12 commences to rotate in plane 90, the effective angle of the wind acting on blade 12 changes since the blade itself is now in motion. Therefore, pitch of blade 12 should be adjusted towards an optimal angle of attack almost as soon as the blade commences to rotate. The improved governing response justifies the small losses in efficiency inherent in the proposed blade design. The blade is designed to optimize performance with predominately low wind speeds.

As seen in FIG. 6b, when blade 12 is at an optimal angle of attack β, the blade generates lift efficiently and rotates quicker. As the wind speed increases, the rate of rotation begins to increase in accordance to the tip speed ratio. To ensure that the blade assembly is not damaged by rotating the blades at too high a rate, the angle of attack of blade 12 is gradually lowered towards zero. When blade 12 is near an angle of attack of zero, as shown in FIG. 7c, the blade generates very little lift and the rotational velocity of the blade will remain at safe levels. Hence, the rotation of blade 12 may be effectively governed by rotating the blade towards an angle of attack of zero degrees. Virtually all prior art low power wind turbines cannot be adjusted in this manner. Further, because of the blades' inherent lightness and stiffness, the upper speed threshold can be substantially higher.

Referring back to FIG. 1, wind turbine blades 12 are mounted to a hub 14 and governor 32. Preferably, governor 32 is adapted to bias blades 12 towards an angle of attack of about 18° when the blades are not moving. Governor 32 is also adapted to pivot blades 12 into their optimal angles of attack when the blades commence to rotate, and to rotate the blades towards an angle of attack of zero degrees when the rotational velocity of the blades exceed a preselected upper limit. A variety of suitable governors have been described which would be suitable for use with the present invention. For example, a suitable governor operated by centrifugal force is described in U.S. Pat. No. 1,930,390.

When a wind turbine blade is at or near an angle of attack of zero degrees (i.e. perpendicular to the wind) the blade will experience strong buffeting forces. The force of a strong wind (in excess of 60 km/hr) acting upon the flat surface of a wind turbine blade can be large enough to cause the blade to flap and buckle. Blades made of composite materials such as carbon fibre or plastics are particularly prone to this phenomenon. To prevent this type of failure, virtually all prior art wind turbines are designed to angle the blade edge into the wind by various tilting mechanism or aerodynamically stall when the wind exceeds a preselected speed. Therefore, at high wind speeds, these prior art wind turbines do not function well. It has been discovered that the aluminum sheet construction of blade 12, in combination with concave surface 38, results in a blade with such a high degree of stiffness that the blade can safely survive wind speeds well in excess of 100 km/hr without flapping or buckling. This structural rigidity, combined with the extra-ordinary lightness of the blade, permits the blade to outperform far more expensive composite extruded or pultruded blades.

To illustrate the effectiveness of the present design, an experimental wind turbine as illustrated in FIG. 1 was constructed using the improved blade design described above. The experimental wind turbine included a governor which was configured to limit the rotational velocity of the blades and a generator for converting the rotation of the blades into electrical current. The experimental wind turbine was exposed to wind velocities ranging from 5 km/hr to 100 km/hr. The energy generated by the experimental wind turbine at various wind speeds was measured by reading the current generated by the generator and plotted as FIG. 10. The wind speed is indicated by line 102, while the generator output is indicated by line 100. As can be seen from the plotted results, the maximal output of the generator was between 12 to 16 Amps. The maximal output was reached with a wind speed of slightly higher than 20 km/hr. Even at a wind speed of 5 km/hr, the experimental wind turbine yielded a generator output of about 1 Amp. At very high wind speeds, (100 km/hr) the wind turbine was observed to operate smoothly without the blades flapping or otherwise moving in a chaotic manner.

The experiment was repeated using a commercially available wind turbine blade of the same length, namely a composite blade made by Southwest Wind Power, Air 403™, with a rotor diameter of 1.1 meters. To ensure the accuracy of the comparison, the composite blades were coupled to the same dynamo. The results of the test using the composite blades are plotted in FIG. 11. As can be seen from the plot in FIG. 11, very little power was generated by the dynamo when the wind speeds were less than 40 km/hr. At 20 km/hr, the control turbine generated less than 2 Amps. Indeed, it was observed that at wind speeds of less than 10 km/hr, the blades on the control turbine did not rotate. At wind speeds approaching 100 km/hr, the turbine was observed to vibrate chaotically, indicating that the turbine blades were flapping as the aeroelastic bending became chaotic and the experiment was ended.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A wind turbine blade comprising:
an elongated chord having a cross-sectional profile having a top surface, a leading edge, a trailing edge and a bottom surface between the leading and trailing edges,
the top surface of the profile configured to substantially conform to a standard lifting wing airfoil,
the leading edge configured to conform substantially to a standard air foil,
the bottom surface configured to have a concave surface extending between the leading edge and the trailing edge.

2. A wind turbine blade as defined in claim 1 wherein the profile has a width extending between the leading and trailing edges, the concave surface extending from the trailing edge for approximately three quarters of width of the profile.

3. A wind turbine blade as defined in claim 1 wherein the elongated chord is hollow.

4. A wind turbine blade as defined in claim 1 wherein the elongated chord is formed from an elongated sheet of metal having a longitudinal axis, first and second opposite side edges, a first section positioned between the first edge and the axis, a second section positioned between the second edge and the axis, the sheet of metal being folded substantially along its longitudinal axis such that the side edges are brought into proximity with each other, the first portion forming the upper surface of the profile and the second portion forming the lower surface of the profile.

5. A turbine blade as defined in claim 4 wherein the side edges are rigidly secured together.

6. A turbine blade as defined in claim 1 wherein the elongated chord is made from an elongated sheet of metal having opposite side edges and a central portion extending longitudinally between the side edges, the sheet of metal being folded along its central portion such that the central portion forms the leading edge, upper surface and lower surface of the profile, the side edges being rigidly attached to each other.

7. A turbine blade as defined in claim 6 wherein the elongated chord is made of sheet aluminum.

8. A turbine blade for use in a wind turbine comprising:
a) an elongated hollow chord having a cross-sectional profile substantially in the form of a standard lifting wing airfoil having a top surface, a bottom surface, a leading edge and a trailing edge,
b) the chord being made from an elongated sheet of metal having opposite first and second edges, an elongated central portion, an elongated first portion extending between the central portion and the first edge and an elongated second portion extending between the central portion and the second edge,
c) the first portion configured to form the top surface of the profile, the second portion configured to form the bottom surface of the airfoil, the central portion configured to form the leading edge, the opposite edges rigidly attached together to form the trailing edge.

9. A wind turbine blade as defined in claim 8 wherein the second portion has an elongated groove extending along its entire length, the groove forming a concave surface extending between the leading edge and the trailing edge.

10. A wind turbine blade as defined in claim 9 wherein the profile has a width extending between the leading and trailing edges, the concave surface extending from the trailing edge for approximately three quarters of width of the profile.

11. A wind turbine blade as defined in claim 8 wherein the elongated chord is formed by bending the elongated sheet along its central portion such that the opposite side edges touch and then rigidly attaching the side edges together.

12. A turbine blade as defined in claim 11 wherein the elongated chord is made of sheet aluminum.

13. A wind turbine blade assembly comprising
a) a hub rotatably mountable to a housing,
b) at least two turbine blades mounted to the hub, each blade having a leading edge and a longitudinal axis, the hub positioning the blades to rotate in a plane of rotation,
c) each blade being pivotally mounted to the hub such that the blade may pivot about it long axis between a first position wherein the blade is positioned at a first angle of attack relative to the plane of rotation and a second position wherein the blade is positioned at a second angle of attack of about 0° relative to the plane of rotation, and
d) a pivoting mechanism operatively coupled to each blade for pivoting the blade into the second position when the blade assembly is rotated beyond a preselected limit.

14. A wind turbine blade assembly as defined in claim 13 wherein the first angle of attack is approximately equivalent to the incipient stall angle for the blade.

15. A wind turbine blade assembly as defined in claim 13 wherein the first angle of attack is approximately 18°.

16. A wind turbine blade assembly as defined in claim 13 wherein the pivoting mechanism biases the blades towards their first position when the blade assembly is rotated at less than the preselected limit.

17. A wind turbine blade assembly as defined in claim 13 wherein each blade comprises an elongated chord having a cross-sectional profile having a top surface, a leading edge, a trailing edge and a bottom surface between the leading and trailing edges, the top surface of the profile configured to substantially conform to a standard lifting wing airfoil, the leading edge configured to conform substantially to a standard air foil, and wherein the bottom surface is configured to have a concave surface extending between the leading edge and the trailing edge.

18. A turbine blade as defined in claim 17 wherein the elongated chord is made from an elongated sheet of metal having opposite side edges and a central portion extending longitudinally between the side edges, the sheet of metal being folded along its central portion such that the central portion forms the leading edge, upper surface and lower surface of the profile, the side edges being rigidly attached to each other.

19. A wind turbine blade as defined in claim 17 wherein the profile has a width extending between the leading and trailing edges, the concave surface extending from the trailing edge for approximately three quarters of width of the profile and wherein the elongated chord is formed from an elongated sheet of metal having a longitudinal axis, first and second opposite side edges, a first section positioned between the first edge and the axis, a second section positioned between the second edge and the axis, the sheet of metal being folded substantially along its longitudinal axis such that the side edges are brought into proximity with each other, the first portion forming the upper surface of the profile and the second portion forming the lower surface of the profile, the side edges being rigidly attached together.

20. A wind turbine as defined in claim 19 wherein the pivoting mechanism is configured to pivot the blades into an angle of attack of approximately between 10° to 12° when the blades begin to rotate, the pivoting mechanism further configured to pivot the blades into an angle of attack of 0° when the blades begin to rotate at a preselected safe upper limit for the wind turbine assembly.
